(19) United States
(12) Patent Application Publication
(10) Pub. No.: US 2005/0266255 A1
(43) Pub. Date: Dec. 1, 2005

(54) Conductive film forming method and conductive material

(75) Inventors: Takeyoshi Kano, Shizuoka-ken (JP); Koichi Kawamura, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/141,318

(22) Filed: Jun. 1, 2005

(30) Foreign Application Priority Data
Jun. 1, 2004 (JP) 2004-163777

(51) Int. Cl. B32B 15/00; C08F 2/46

(52) U.S. Cl. 428/473.5; 427/496

(57) ABSTRACT

The invention provides a method for forming a conductive film including: applying energy to a surface of a base material including a polyimide having at least one structural unit represented by Formulae (1) or (2) and having a polymerization initiating site in a skeleton thereof to generate an activation site on the surface of the base material; forming a graft polymer that directly bonds to the surface of the base material and that interacts with either an electroless plating catalyst or a precursor thereof by using the activation site as a starting point; applying either an electroless plating catalyst or a precursor thereof to the graft polymer; and electroless plating. 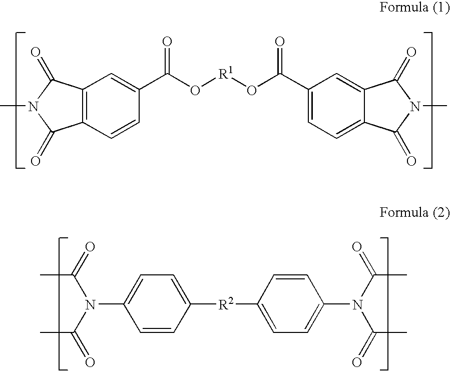
R¹ represents a bivalent organic group. R² represents one of Formulae (3) to (6). 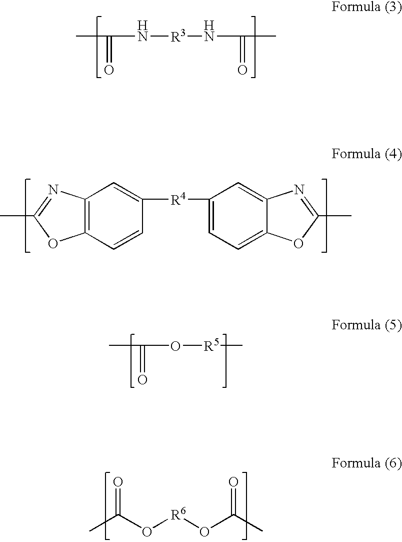
R³, R⁴, R¹ and R⁵ independently represent a bivalent organic group.

### CROSS-REFERENCE TO RELATED APPLICATION

This application claims priority under 35 USC 119 from Japanese Patent Application No. 2004-163777, the disclosure of which is incorporated by reference herein.

### BACKGROUND OF THE INVENTION

1. Field of Invention

This invention relates to a conductive film forming method and a conductive material, and in detail, specifically relates to a conductive film forming method that provides conductive films which are superior in adhesion property, wearing resistance and dimensional stability on polyimide base materials having small moisture absorption ratio and hygroscopic expansion coefficient in a simple processes, and further relates to a conductive material that is obtainable by the method.

2. Description of the Related Art

Polyimide is a polymer which has extremely high stability against heat, thus it is used in various materials which are required for heat resistance. Specifically, for the purpose of utilization in circuit substrates, which ordinarly requires to have resistance against heat of approximately 250° C. or higher, polyimide substrates are generally used.

One typical method for forming a circuit substrate using a polyimide substrate includes attaching a copper film having an adhesive onto one surface of a polyimide substrate and selectively etching the copper film so as to form a predetermined pattern wiring. However, this method has a problem that a heat resistance of the obtained circuit substrate tends to become low since a heat resistance of the adhesive which adheres the copper film and the polyimide substrate is low.

Accounting for the above, a method for forming a circuit substrate without a utilization of an adhesive was recently provided (see Japanese Patent Application Laid-Open (JP-A) No. 200346223). The method includes forming a metallic film on a polyimide substrate by spattering and then conducting plating so as to form a copper film on the polyimide substrate. However, this method has a problem that an adherence between the copper film and the substrate is insufficient since this method does not use an adhesive. In order to solve the problem, a method for improving the adherence between the copper film and the polyimide substrate, the method including plasma-processing the polyimide substrate, introducing a polymerization initiating group into a surface of the polyimide substrate, and polymerizing monomers by using the polymerization initiating group as a starting site so as to introduce a surface graft polymer onto the surface of polyimide substrate, has been proposed (N. Inagaki, S. Tasaka, and M. Masumoto: “Macromolecules”, 29, pp. 1642-1648). However, since this method requires the elaborate plasma-processing, simpler methods has been desired.

Also, when a polyimide substrate is used in conductive material applications such as flexible wiring, TAB (Tape Automated Bonding) tapes, laminated wiring substrates or the like, it is required that the moisture absorption ratio and hygroscopic expansion coefficient of the polyimide is as small as possible from the perspectives of reliability and dimensional stability. Again from the perspective of dimensional stability it is also required that the hygroscopic expansion coefficient is also low. This is because during electrical wiring type manufacturing processes there are repeated cycles of processes, such as washing/drying, where the polyimide substrate absorbs water and then is dried out. Consequently, as a result of moisture absorption/moisture loss in the base film, there are large changes in the dimensions of the metallic wiring parts, and this can lead to errors when mounting an IC chip or the like. It is also because when heat is added during mounting, the moisture content in the polyimide can evaporate, leading to large dimensional changes, which again can lead to the occurrence of errors. Also, since polyimide substrates are also used in application where they are bent or folded, a high degree of elasticity is required from the perspective of flexibility.

Regarding polyimides exhibiting high elasticity, such as those described in Japanese Patent Application Laid-Open (JP-A) No. 200346223 and in “Macromolecules” No. 29, p1642 to p1648 by N Inagaki, S Tasaka, and M Masumoto, if, for making the main chain of the polyimide, a general acid of pyromellitic dianhydride is used as the material to synthesize the polyimide, then the exhibiting of high elasticity can easily be achieved. However, polyimides which are obtained like this cannot exhibit low hygroscopicity because the polarization of the imide groups is high.

In order to overcome this problem, it is generally effective to reduce the quantity of imide groups in the molecular structure, and the use of flexible groups of long, monomer chains within the main chain is common. However, if simply the number of imide groups in the molecular structure is reduced, then this can lead to a reduction in the elasticity and an excessive increase in the linear expansion coefficient, sacrificing dimensional stability. Also, another problematic point about the characteristics of conventional polyimides is that, if long linear monomers are used, then the molecular chain packing becomes difficult, and it is difficult to achieve sufficient toughness, and in some case it is difficult to form films. Like the above, the required characteristics of a polyimide need to consider lots of other perspectives as well as low linear expansion coefficient, reducing hygroscopicity, and increasing elasticity. However, the current situation is that if one characteristic is satisfied another is sacrificed, and obtaining a polyamide film possessing all of multiple good characteristics posses significant problems, with an influence on multiple-functions of conductive patterning materials to which polyimide films are applied.

### SUMMARY OF THE INVENTION

The invention has been made in consideration of the above problems, and provides a method for forming a conductive film having high heat resistance, superior adhesion to a surface of a base material and high endurance which uses a polyimide base material with low hygroscopicity, low hygroscopic expansion coefficient, and high elasticity in a simple procedure, and further provides a conductive material that has high heat resistance and dimensional stability and is obtained by the method.

The inventors of the invention, after investigating the above problems and undertaking diligent research have discovered that the dimensional stability of a conductive film can be maintained by: using a polyimide base material that has low hygroscopicity, low hygroscopic expansion coefficient, and high elasticity; using specific structural units; and, by using the polyimide introduced polymerization initiation sites on the structural skeleton thereof. In addition it has been discovered that when using such a polyimide base material, by applying energy, such as UV light, in the form of a pattern, and by using these activation sites as the starting points, by forming a graft polymer that directly bonds to the surface of the base material and that interacts with either an electroless plating catalyst or a precursor thereof by using the activation site as a starting point, the surface of the polyimide base material can easily be caused to have activation sites (causing the occurrence of radicals).

Namely, the present invention provides a method for forming a conductive film comprising: applying energy to a surface of a base material including a polyimide having at least one structural unit selected from the group consisting of those represented by the following Formula (1) or Formula (2) and having a polymerization initiating site in a skeleton thereof to generate an activation site on the surface of the base material; forming a graft polymer that directly bonds to the surface of the base material and that interacts with either an electroless plating catalyst or a precursor thereof by using the activation site as a starting point; applying either an electroless plating catalyst or a precursor thereof to the graft polymer; and electroless plating.

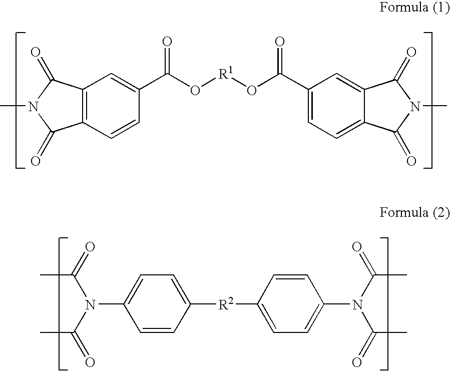

In Formulae (1) and (2), R¹ represents a bivalent organic group, and R² represents a partial structure represented by one of Formulae (3) to (6).

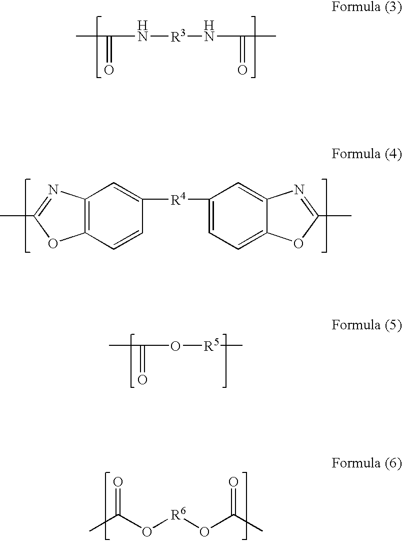

In Formulas (3) to (6), each of R³, R⁴, R⁵ and R⁵ independently represents a bivalent organic group.

The present invention further provides a method for forming a conductive material comprising: a base material including a polyimide having at least one structural unit selected from the group consisting of those represented by the the above Formula (1) or Formula (2) and having a polymerization initiating site in a skeleton thereof to generate an activation site on the surface of the base material; and a conductive film comprising a graft polymer that directly bonds to the surface of the base material and a conductive material that is attached to the graft polymer.

### DETAILED DESCRIPTION OF THE INVENTION

Hereinafter, the present invention is explained in detail.

1. Conductive Film Forming Method

The method for forming a conductive film of the invention is characterized by having at least: applying energy to a surface of a base material including a polyimide having at least one structural unit selected from the group consisting of those represented by the following Formula (1) or Formula (2) and having a polymerization initiating site in a skeleton thereof to generate an activation site on the surface of the base material; forming a graft polymer that directly bonds to the surface of the base material and that interacts with either an electroless plating catalyst or a precursor thereof by using the activation site as a starting point (hereinafter sometimes referred as “surface grafting (process)”); applying either an electroless plating catalyst or a precursor thereof to the graft polymer (hereinafter sometimes referred as “electroless plating catalyst and the like-imparting (process)”); and conducting electroless plating (hereinafter sometimes referred as “electroless plating (process)”)

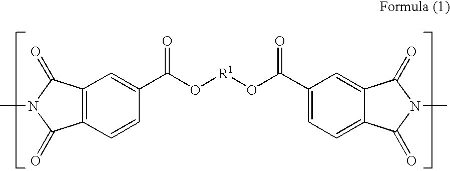

In Formula (1), R¹ represents a bivalent organic group. Preferable examples of the bivalent group include a straight-, a branched- or a cyclic-aliphatic group or a straight-, a branched- or a cyclic-aromatic group. Each of these groups may further has a substituent group if such a substituent group can be introduced thereto.

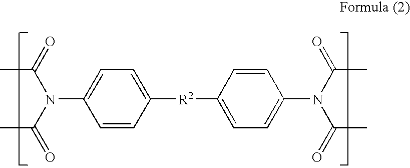

In Formula (2), R² represents a partial structure represented by one of Formulae (3) to (6).

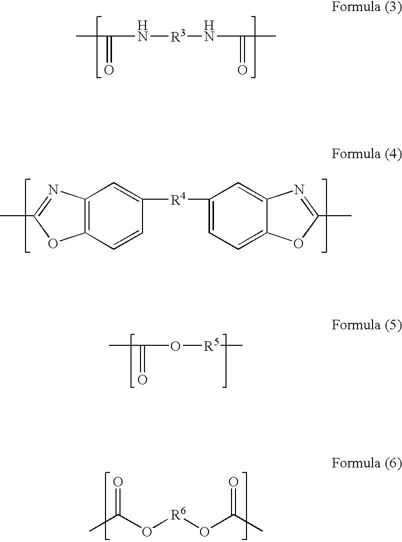

In Formulas (3) to (6), each of R³, R⁴, R⁵ and R⁵ independently represents a bivalent organic group.

Surface Grafting

Firstly, surface grafting in the conductive film of the invention is explained in detail.

Production of Base material including a polyimide having at least one structural unit selected from the group consisting of those represented by Formula (1) or Formula (2) and having a polymerization initiating site in a skeleton thereof.

The base material according to the invention is a base material including the polyimide having at least one structural unit selected from the group consisting of those represented by Formula (1) or Formula (2) and having the polymerization initiating site in the polymer skeleton thereof (hereinafter, sometimes simply referred to as a “polyimide base material”). The “polymer skeleton” in the invention includes the main chain and side chain(s) of the polyimide.

The polymerization initiating site represents a moiety which can be activated by applied energy using a UV light or the like to thereby generate the activation site (radical speices) in the structure thereof. The activation site can be generated in such modes that the activation site is directly generated in the polymerization initiating site or that the generation of the activation site is induced in the polymerization initiating site and the vicinity thereof by extracting hydrogen from the vicinity of the polymerization initiating site.

The polyimide used as the base material in the invention is a polyimide including at least one structural unit selected from the group consisting of those represented by Formula (1) or Formula (2) and including the polymerization initiating site in the skeleton thereof (hereinafter, referred to as a “specific polyimide”). The inclusion of such structures enables the generation of the graft polymer, which will be described later, as well as exhibiting low hygroscopicity, low hygroscopic expansion coefficient and high elasticity, on the base material surface in an easy and simplified manner. The polymerization initiating site in the specific polyimide in the invention is preferably included in the main chain In view of obtaining heat resistance and easiness in production, the polyimide preferably has the polymerization initiating site in main chain thereof.

The base material including the specific polyimide according to the invention can be prepared by implementing the following <1> to <3> in that order.
<1> Production of the polyimide precursor
<2> Molding of the polyimide precursor
<3> Change of the structure of the polyimide precursor into a polyimide structure through a heating process

The above-mentioned processes <1> to <3> are described below.

<1> Production of Polyimide Precursor

The compound represented by the following Formula (7) is used as the polyimide precursor compound used for the production of the specific polyimide according to the invention.

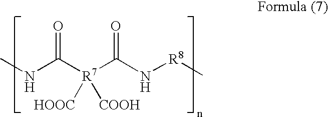

In Formula (7), R⁷ is a quadrivalent organic group, R⁸ is a bivalent organic group, n is an integer of 2 or more. Also, the molecule for construction of any one of the polyimide precursor compound represented by Formula (7) includes as a structural unit for R⁷ a structure represented by Formula (8) below and for R⁸ a structure represented by Formula (9) below and, in R⁷ and/or R⁸ a structure which includes a polymerization initiating function.

In other words, in the same molecule there is included for R⁷ and R⁸ multiple structural units including a structure shown by Formula (8) below, a structure shown by Formula (9) below, and a structure which has a polymerization initiation function. The polymerization initiation function containing structure represented by Formula (7) corresponds to the specific polyimide polymerization initiation site of the invention. Further, it is preferable that the poymerization initiation function possessing structure has a photopolymerization function.

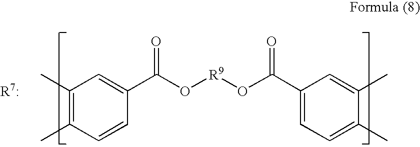

In Formula (8), R⁹ has the same meaning as R¹ in Formula (1).

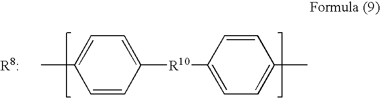

In Formula (9), R¹⁰ is one of the partial structures shown in Formulas (10), (11), (12) or (13) below. These correspond to each of the specific polyimide of Formulas (3), (4), (5) or (6) respectively.

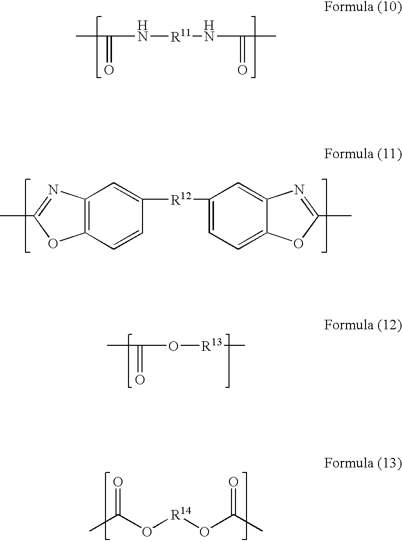

R¹¹ in Formula (10), R¹² in Formula (11), R¹³ in Formula (12), and R¹⁴ in Formula (13) has the same meaning as R³ in Formula (3), R⁴ in Formula (4), R⁵ in Formula (5), and R⁶ in Formula (6) respectively.

From the perspective of the graft polymerization reaction undergone on the base material surface, the amount ratio of structures including the polymerization initiation function included in the R⁷ and/or R⁵ compounds of Formula (7) is preferably 10 mol % to 60 mol %, and more preferably 20 mol % to 60 mol %. Also, from the perspectives of hygroscopic expansion coefficient and dimensional stability, the amount ratio of the partial structures for R⁷ shown in Formula (8), and/or the partial structures for R⁸ shown in Formula (9) included are preferably 20 mol % to 70 mol %, and more preferably 25 mol % to 70 mol %.

The compound represented by Formula (7) can be obtained by reacting tetracarboxylic acid dianhydride represented by the following Formula (14) and a diamine compound represented by the following Formula (15) in an organic solvent. As additional elements, bivalent alcohols can be added.

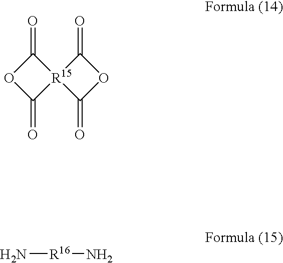

R¹⁵ shown in Formula (14) is equivalent to R⁷ in Formula (1), and R¹⁶ shown in the above Formulas (15) is equivalent to R⁸ in Formula (15).

Tetracarboxylic Acid Dianhydride Represented by Formula (14)

When a partial structure represented by Formula (8) is introduced into a compound represented by Formula (7) by using a diamine compound represented by Formula (14), a compound represented by the following Formula (16) can be used.

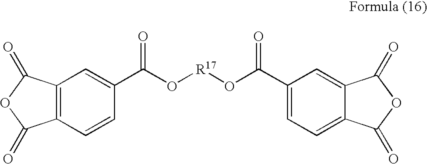

In Formula (16), R¹⁷ corresponds to R¹ in Formula (1) and R⁹ in Formula (8), and represent a bivalent group. Preferable examples of the bivalent group include a straight-, a branched- or a cyclic-aliphatic group or a straight-, a branched- or a cyclic-aromatic group. Each of these groups may further has a substituent group if such a substituent group can be introduced thereto.

R¹⁷ preferably represents a bivalent organic group selected from the group consisting of the structures represented by the following formulas. In the following formulas, R¹⁸ represents CH₃—, Cl—, Br—, F—, CH₃O—, or a bivalent group formed by linking plurality of these. n represents an integer selected from 1 to 3. X represents a monovalent substituent group selected from the group consisting of a hydrogen atom, a halogen atom, a carboxyl group, a lower alkyl group having 1 to 6 carbon atoms, and a lower alcoxy group having 1 to 6 carbon atoms. Each of Y and Z independently represents a monovalent substituent group selected from the group consisting of a hydrogen atom, a halogen atom, a carboxyl group, a lower alkyl group having 1 to 6 carbon atoms, and a lower alcoxy group having 1 to 6 carbon atoms. A represents a bivalent linking group selected from the group consisting of an oxygen atom, a sulfur atom, —CO—, —SO—, —SO₂—, and —CH₂—.

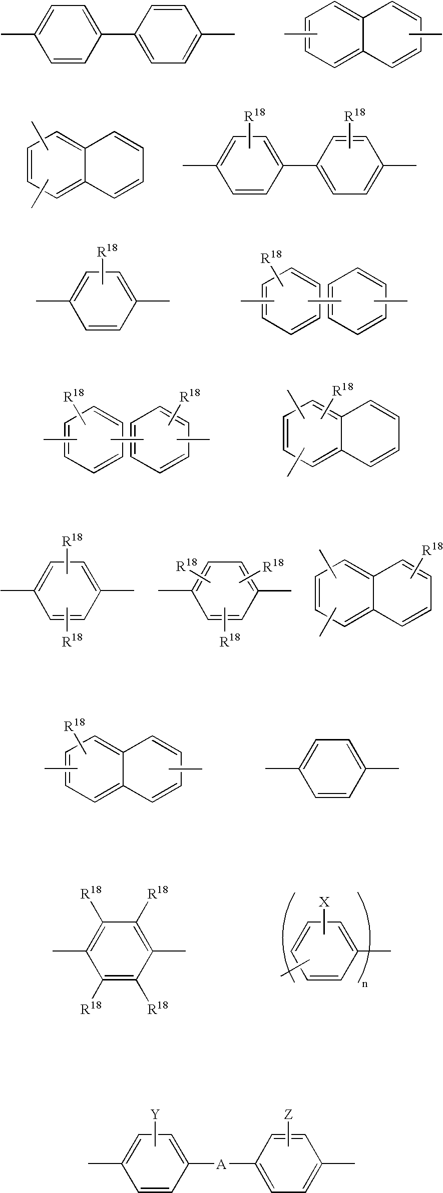

In addition to the above, examples of the tetracarboxylic acid dianhydride represented by Formula (14) include a pyromellitic acid dianhydride, 2,3,6,7-napthalene tetracarboxylic acid dianhydride, 1,4,5,8-napthalene tetracarboxylic acid dianhydride, 1,2,5,6-napthalene tetracarboxylic acid dianhydride, p-terphenyl-3,4,3″,4″-tetracarboxylic acid anhydride, m-terphenyl-3,4,3″,4″-tetracarboxylic acid anhydride, bicyclo (2,2,2) oct-7-ene-2,3,5,6-tetracarboxylic acid anhydride, ethylene tetracarboxylic acid dianhydride, cyclopentane tetracarboxylic acid dianhydride, pyromellitic acid dianhydride, 3,3′,4,4′-biphenyl tetracarboxylic acid dianhydride, 2,2′3,3′-biphenyl tetracarboxylic acid dianhydride, 2,2-bis (3,4′-dicarboxyphenyl) propane dianhydride, 2,2-bis (2,3-dicarboxyphenyl) propane dianhydride, bis (3,4-dicarboxyphenyl) ether dianhydride, bis (3,4-dicarboxyphenyl) sulfone dianhydride, 1,1-bis (2,3-dicarboxyphenyl) ethane dianhydride, bis (2,3-dicarboxyphenyl) methane dianhydride, bis (3,4-dicarboxyphenyl) methane dianhydride, 2,2-bis (3,4-dicarboxyphenyl)-1,1,1,3,3,3-hexafluoropropane dianhydride, 2,2-bis (2,3-dicarboxyphenyl)-1,1,1,3,3,3-hexafluoropropane dianhydride, 2,3,6,7-naphthalene tetracarboxylic acid dianhydride, 1,4,5,8-naphthalene tetracarboxylic acid dianhydride, 1,2,5,6-naphthalene tetracarboxylic acid dianhydride, 1,2,3,4-benzene tetracarboxylic acid dianhydride, 3,4,9,10-perylene tetracarboxylic acid dianhydride, 2,3,6,7-anthracene tetracarboxylic acid dianhydride, 1,2,7,8-phenanthrene tetracarboxylic acid dianhydride and the like.

When R¹⁵ in Formula (14) is the group that has the structure having the polymerization initiation property, examples of the the structure having the polymerization initiation property include (a) aromatic ketones, Examples of the structure having the polymerization initiation property (b) onium salt compounds, (c) organic peroxides, (d) thiocompounds, (e) hexarylbiimidazole compounds, (f) ketoxime ester compounds, (g) borate compounds, (h) azinium compounds, (i) active ester compounds, (j) compounds having a carbon halogen bond, (k) pyridiums compounds, and the like.

When R¹⁵ is a group including a structure having a polymerization initiation property, the bonding of the carboxylic acid anhydride structures, two of which are included in Formula (14), and R¹⁵ may be in any modes, and examples thereof include a mode in which the carboxylic acid anhydride structures are bonded at any spot in the structures having the polymerization initiation property; and a mode in which the carboxylic acid anhydride structures are bonded to any spot in the structures having the polymerization initiation property via linking groups.

In terms of the heat resistance of the polyimide, (a) aromatic ketones are preferably selected in the case of the structure having the polymerization initiation property. Specific examples of (a) aromatic ketones are mentioned below. However, the invention is not limited thereto.

Aromatic Ketones

In the invention, preferable examples of (a) aromatic ketones as the structure having the polymerization initiation property include compounds having a benzophenone skeleton or a thioxanthone skeleton described on pp. 77 to 117 of “RADIATION CURING IN POLYMER SCIENCE AND TECHNOLOGY” J. P. Fouassier, J. F. Rabek (1993). For example, the following compounds can be mentioned.

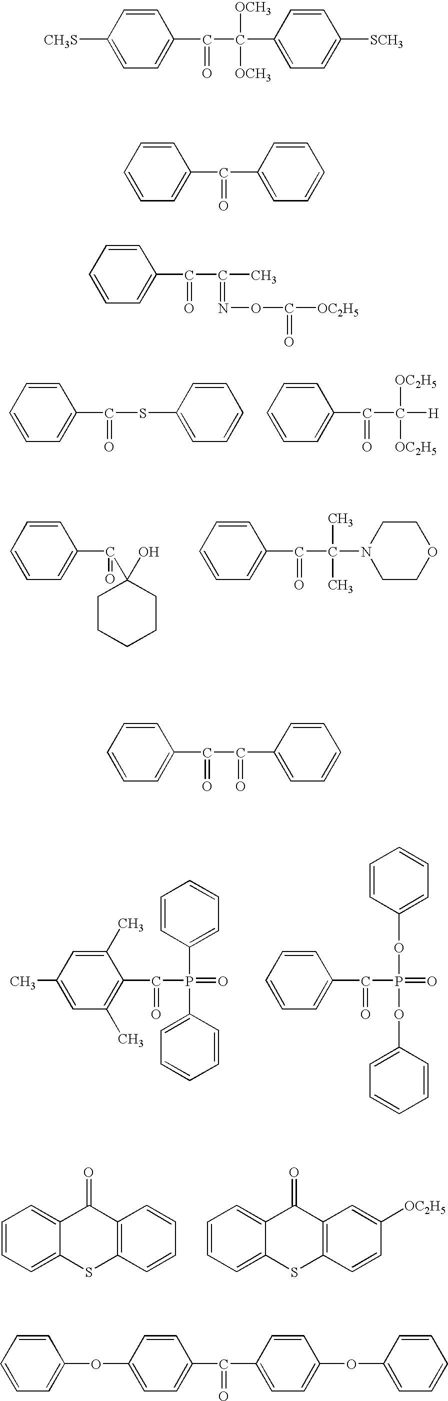

Particularly preferable examples of (a) aromatic ketones are listed below.

Particularly preferable examples of (a) aromatic ketones include α-thiobenzophenone compounds described in Japanese Patent Application Publication (JP-B) No. 47-6416 and benzoinether compounds described in JP-B No. 47-3981. For example, the following compound can be mentioned

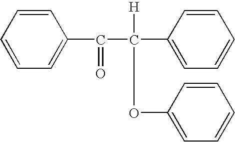

Preferable examples also include α-substituent benzoin compounds described in JP-B No. 47-22326, such as the following compound.

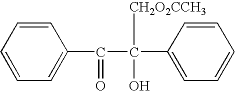

Preferable examples further include benzoin compounds described in JP-B No. 47-23664, aroylphosphonic acid esters described in JP-B No. 57-30704 and dialkoxybenzophenones described in JP-B No. 60-26483, such as the following compound.

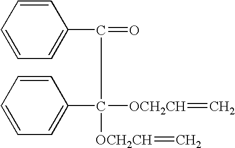

Preferable examples further include benzoin ethers described in JP-B Nos. 60-26403 and 62-81345, such as the following example.

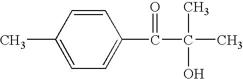

Preferable examples further include α-minobenzophenones described in JP-B No. 1-34242, U.S. Pat. No. 4,318,791 and EP Patent No. 02456A1, such as the following compounds.

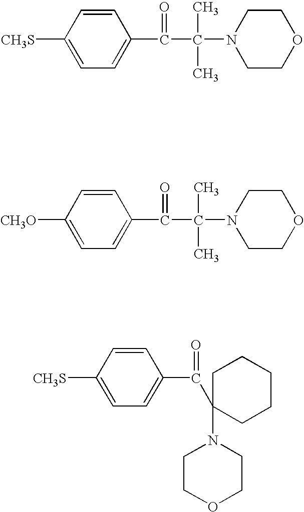

Preferable examples further include p-di (dimethylaminobenzoyl) benzenes described in JP-A No. 2-211452, such as the following compound.

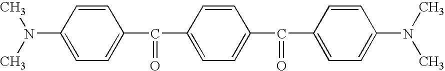

Preferable examples further include thio-substituted aromatic ketones described in JP-A 61-194062, such as the following compound.

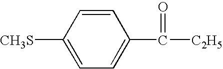

Preferable examples further include acylphosphine sulfides described in JP-B No. 2-9597, such as the following compounds.

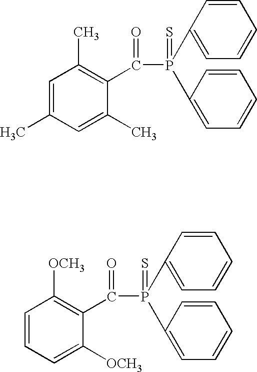

Preferable examples further include acylphosphines described in JP-B No. 2-9596, such as the following compounds.

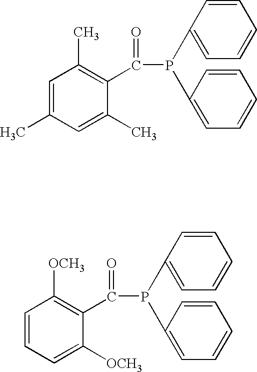

Preferable examples further include thioxanthones described in JP-B No. 63-61950 and coumarins and the like described in JP-B No. 5942864.

Specific examples of the particularly preferred modes of the tetracarboxylic dianhydride represented by Formula (14), in which R¹ is the polymerization initiating group, are shown below. However, the invention is not limited to these examples.

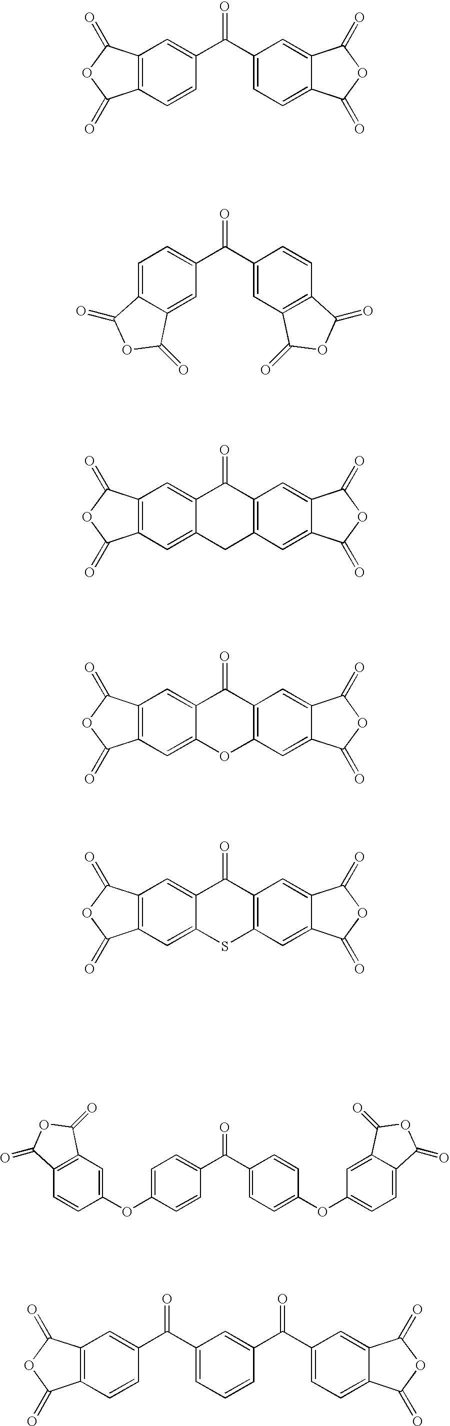

The tetracarboxylic dianhydride represented by Formula (14) may be used singly or in combination of two or more thereof.

Diamine Compound Represented by Formula (15)

When a partial structure represented by Formula (9) is introduced into a compound represented by Formula (9) by using a diamine compound represented by Formula (15), a compound represented by the following Formula (17) can be used.

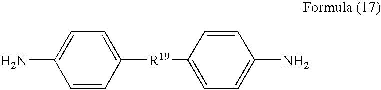

In Formula (17), R¹⁹ represents a partial structure represented by the following Formulas (18), (19), (20) or (21).

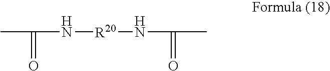

In Formula (18), R²⁰ represents a straight-, branched-, or cyclic-alkyl group having 1 to 18 carbon atoms, an aralkyl group having 7 to 12 carbon atoms, an alkenyl group having 2 to 8 carbon atoms, an alkynyl group having 2 to 8 carbon atoms, an aromatic group having 6 to 18 carbon atoms, or a group containing aromatic groups linked with each other by a linking group(s). Each of these groups may further has a substituent.

Specific examples of the diamine compound represented by Formula (15), that contains a partial structure represented by Formula (18), include the following compounds.

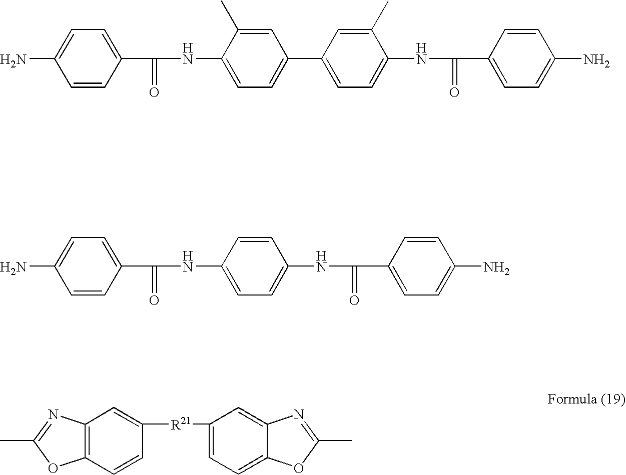

In Formula (19), R²′ represents a single bond, a straight-, branched-, or cyclic-alkyl group having 1 to 18 carbon atoms, an aralkyl group having 7 to 12 carbon atoms, an alkenyl group having 2 to 8 carbon atoms, an alkynyl group having 2 to 8 carbon atoms, an aromatic group having 6 to 18 carbon atoms, or a group containing aromatic groups linked with each other by a linking group(s). Each of these groups may further has a substituent.

Specific examples of the diamine compound represented by Formula (15), that contains a partial structure represented by Formula (19), include the following compounds.

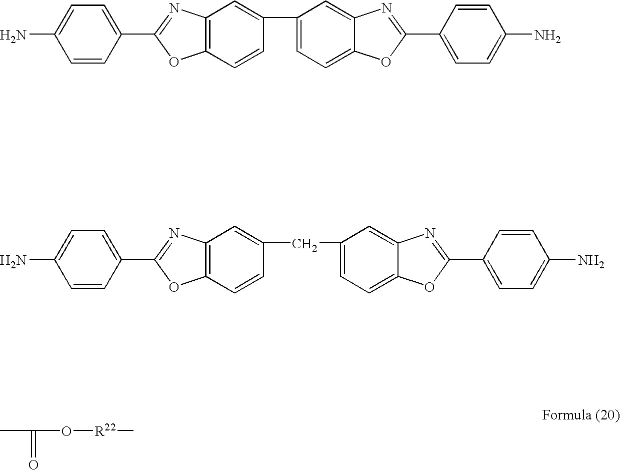

In Formula (20), R²² represents a single bond, a straight-, branched-, or cyclic alkyl group having 1 to 18 carbon atoms, an aralkyl group having 7 to 12 carbon atoms, an alkenyl group having 2 to 8 carbon atoms, an alkynyl group having 2 to 8 carbon atoms, an aromatic group having 6 to 18 carbon atoms, or a group containing aromatic groups linked with each other by a linking group(s). Each of these groups may further has a substituent.

Specific examples of the diamine compound represented by Formula (15), that contains a partial structure represented by Formula (20), include the following compounds.

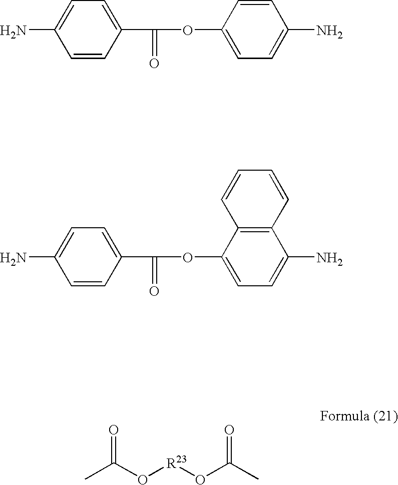

In Formula (21), R²³ represents a bivalent organic group selected from the group consisting of the structures represented by the following formulas. In the following formulas, R²⁴ represents CH₃—, Cl—, Br—, F— or CH₃O—. n represents an integer selected from 1 to 3. B represents a monovalent substituent group selected from the group consisting of a hydrogen atom, a halogen atom, a carboxyl group, a lower alkyl group having 1 to 6 carbon atoms, and a lower alcoxy group having 1 to 6 carbon atoms. Each of C and D independently represents a monovalent substituent group selected from the group consisting of a hydrogen atom, a halogen atom, a carboxyl group, a lower alkyl group having 1 to 6 carbon atoms, and a lower alcoxy group having 1 to 6 carbon atoms. A represents a bivalent linking group selected from the group consisting of an oxygen atom, a sulfur atom, —CO—, —SO—, —SO₂—, and —CH₂—.

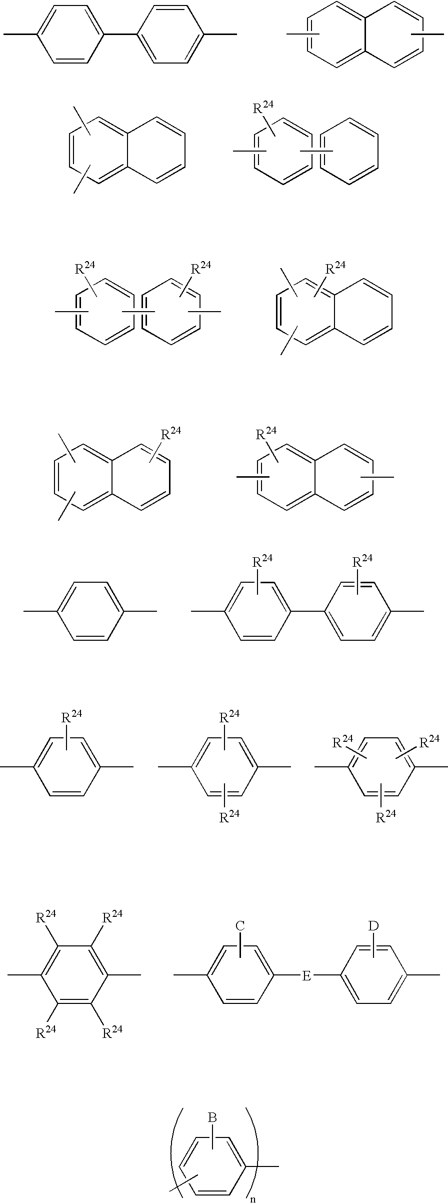

Specific examples of the diamine compound represented by Formula (15) further include m-phenylenediamine, p-phenylenediamine, benzidine, 4,4″-diaminoterphenyl, 4,4-diaminoquaterphenyl, 4,4″-diaminodiphenylether, 4,4′-diaminodiphenylmethane, diaminodiphenylsulfone, 2,2-bis (p-aminophenyl)propane, 2,2-bis (p-aminophenyl) hexafluoropropane, 1,5-diaminonaphthalene, 2,6-diaminonaphthalene, 3,3′-dimethylbenzidine, 3,3′-dimethoxybenzidine, 3,3′-dimethyl-4,4-diaminodiphenylether, 3,3′-dimethyl-4,4′-diaminodiphenylmethane, 1,4-bis(p-aminophenoxy) benzene, 4,4-bis (p-aminophenoxy) biphenyl, 2,2-bis {4-p-aminophenoxy)phenyl}propane, 2,3,5,6-tetraamino-p-phenylenediamine, and the like.

When R¹⁶ in Formula (15) is the group that has the structure having the polymerization initiation property, examples of the structure having the polymerization initiation property include those similar to which described for R¹⁵ in Formula (14), namely, (a) aromatic ketones, Examples of the structure having the polymerization initiation property (b) onium salt compounds, (c) organic peroxides, (d) thiocompounds, (e) hexarylbiimidazole compounds, (f) ketoxime ester compounds, (g) borate compounds, (h) azinium compounds, (i) active ester compounds, ( ) compounds having a carbon halogen bond, (k) pyridiums compounds, and the like.

When R¹⁶ is a group including a structure having a polymerization initiation property, the bonding of the amino group, two of which are included in Formula (14), and R¹⁶ may be in any modes, and examples thereof include a mode in which the two amino groups are bonded at any spot in the structures having the polymerization initiation property; and a mode in which two amino groups are bonded to any spot in the structures having the polymerization initiation property via linking groups.

In terms of the heat resistance of the polyimide, (a) aromatic ketones are preferably selected as the structure having the polymerization initiation property.

Specific examples of (a) aromatic ketones similar to those described for Formula (14). However, the invention is not limited thereto.

Specific examples of the diamine compound represented by Formula (15), in which R¹⁶ is a group including a structure having a polymerization initiation property, are shown below. However, the invention is not limited thereto.

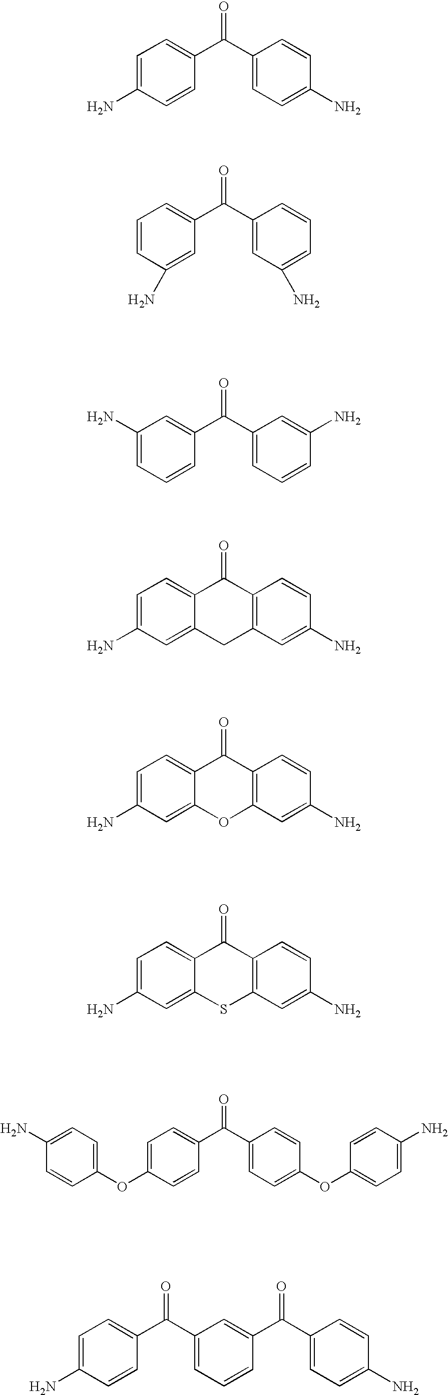

The diamine compound represented by Formula (15) may be used singly or in combination of two or more thereof.

Synthesis of Compound Represented by Formula (7)

The polyimide precursor compound represented by Formula (7) can be synthesized by using a tetracarboxylic acid anhydride represented by Formula (14) and a diamine compound represented by Formula (15), and a dialcohol compound in accordance with needs.

Specific example of the synthesis is that a diamine compound represented by Formula (15) is dissolved in a solvent, a tetracarboxylic acid anhydride represented by Formula (14) is added, and a reaction is conducted under a reaction temperature, which is less than 0° C. or in a range of 40 to 80° C. and selected in accordance with the compounds used therein.

Solvent

The solvent used in the synthesis can be appropriately selected with regard to a solubility of each constituent. Suitable examples include ethylene dichloride, cyclohexanone, cyclopentanone, 2-heptanone, methylisobutyl ketone, γ-butyrolactone, methyletyl ketone, methanol, ethanol, dimethylmidazolidinone, ethyleneglycolmonomethyl ether, ethyleneglycolmonoethyl ether, ethyleneglycoldimethyl ether, 2-methoxyethyl acetate, ethyleneglycol monoethylether acetate, propyleneglycol monomethylether (PGME), propyleneglycol monomethyletheracetate (PGMEA), tetraethyleneglycoldimethylether, triethyleneglycol monobutylether, triethyleneglycolmonomethylether, isopropanol, ethylenecarbonate, acetic ether, butyl acetate, methyl lactate, ethyl lactate, methyl methoxypropionate, ethyl ethoxypropionate, methyl, ethyl pyruvate, propyl pyruvate, N,N-dimethyl formamide, dimethyl acetamide, dimethyl sulfoxide, N-methylpyrrolidone, tetrahydrofuran, di-isopropyl benzene, toluene, xylene, mesitylene, N-methyl-2-pyrrolidone, dimethylformamide, hexamethylphosphorous amide, and the like. These solvents can be used singly or in a combination of two or more.

Among these, examples of particularly preferable solvents include propyleneglycol monomethyletheracetate, propyleneglycol monomethylether, 2-heptanone, cyclohexanone, y-butyrolactone, ethyleneglycol monomethylether, ethyleneglycol monoethylether, ethyleneglycol monoethylether acetate, propyleneglycol monomethylether, propyleneglycol monoethylether, ethylene carbonate, butyl acetate, methyl lactate, ethyl lactate, methyl methoxypropionate, ethyl ethoxypropionate, N-methylpyrrolidone, N,N-dimethyl formamide, tetrahydrofuran, methylisobutyl ketone, xylene, mesitylene, and di-isopropyl benzene.

A weight-average molecular weight of the compound (the polyimide precursor compound) represented by Formula (7) is generally approximately 1,000 to 10,000,000, preferably approximately 1,000 to 1,000,000, and more preferably approximately 2,000 to 1,000,000.

Specific examples of the polyimide precursor compound represented by Formula (7) are shown below. In the followings, n represents a repeating number of each unit. It should be noted that the invention is not limited thereto. 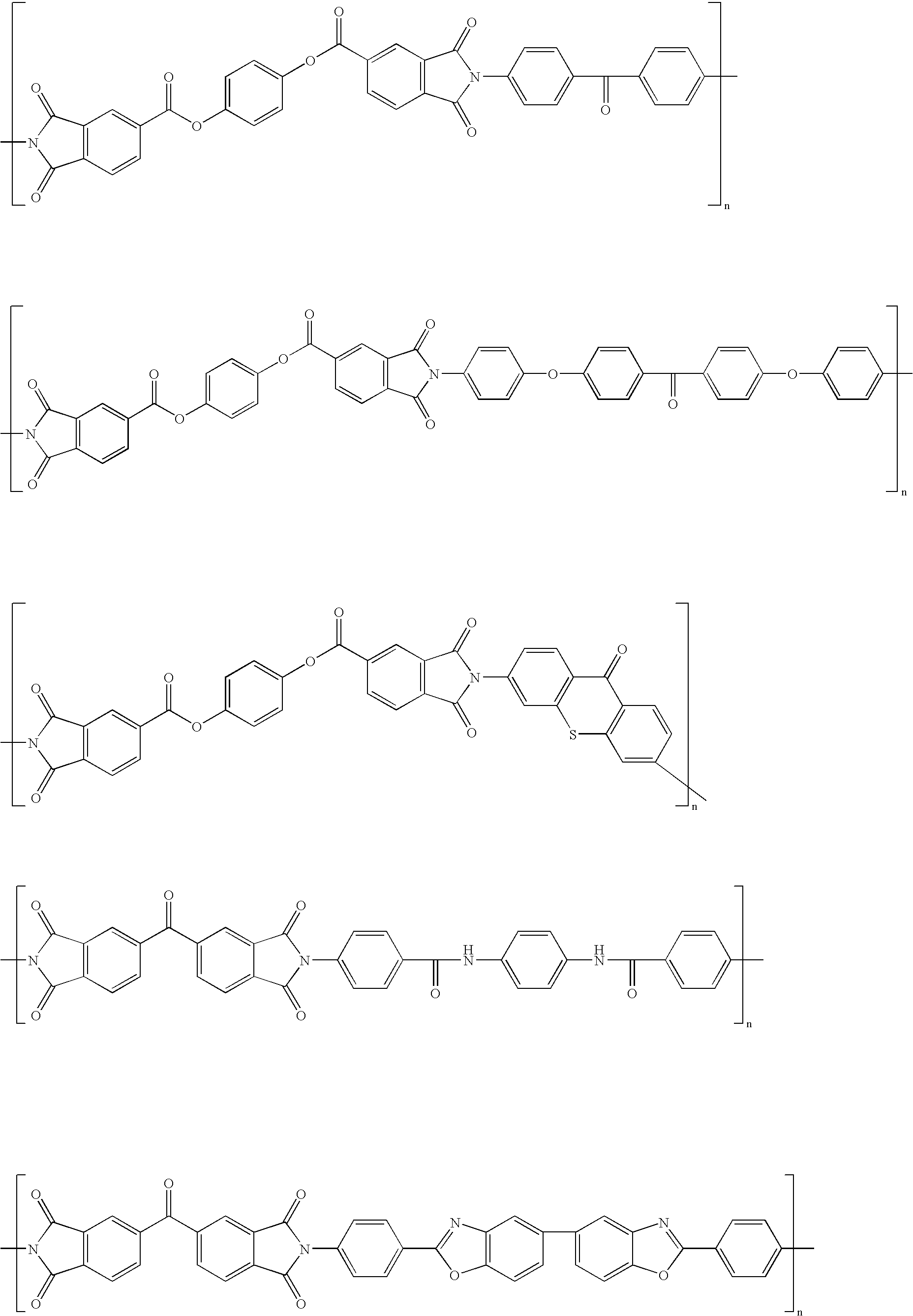 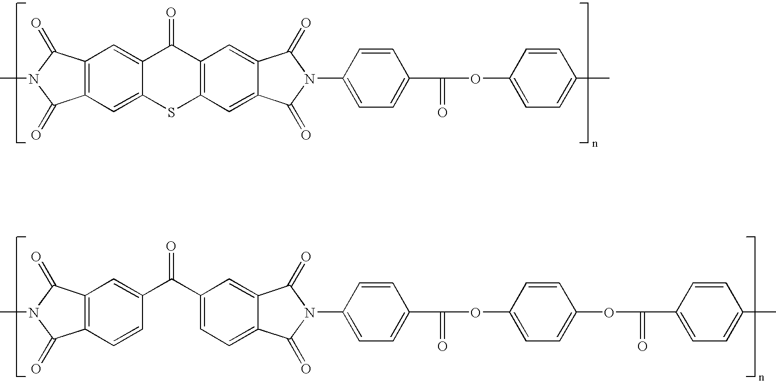
<2> Molding of Polyimide Precursor

Subsequent to the process <1>, the polyimide precursor is molded. As the polyimide precursor that is used in the invention, the compound represented by Formula (7) and obtained in <1> may be used alone, or in combination with a polyimide precursor having a different structure (compound including no group having the polymerization initiation property). When plurality kinds of polyimide precursors are used, the content ratio of the compound represented by Formula (7) and the plurality kinds of polyimide precursors included in the entire polyimide precursor is preferably in a range that the compound represented by Formula (7) being included in an amount of at least 50 mass %, and more preferably in an amount of at least 80 mass % relative to total amount of polyimide precursors.

There is no particular limitation to a shape of the molded polyimide precursor. However, a film shape or a plate shape is preferable in terms of manufacturing convenience.

Molding

As a method of the molding, any of biaxial stretching film molding, injection molding, extrusion molding, blow molding, compression molding, reaction molding, FRP molding, heat molding, roll sheet molding, calender molding, laminated molding and rotational molding can be applied. The polyimide precursor can be spread on a glass substrate or the like and dried to be thereby formed into a film shape.

<3> Change of Structure of Polyimide Precursor into Polyimide Structure by Heating

Heating is conducted to the polyimide precursor molded in <2>. The heating is performed at about 100 to 450° C. for one minute to one hour, and the structure of the compound represented by Formula (7) (polyimide precursor) is thereby changed into the structure of the polyimide represented by the following Formula (22). Thus, the base material of the invention can be obtained.

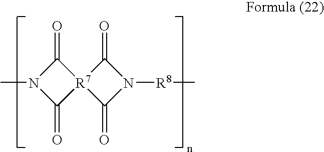

R⁷, R⁸ and n in Formula (22) are similar to R⁷, R⁸ and n in Formula (1), and preferable ranges thereof are similar to those of R⁷, R⁸ and n in Formula (I), too.

Next, the present invention includes applying energy to a surface of the thus-obtained polyimide base material so as to generate an activation site on the surface of the base material, and forming a graft polymer that directly bonds to the surface of the base material and that interacts with either an electroless plating catalyst or a precursor thereof by using the activation site as a starting point (namely, surface graft polymerization).

In the invention, the graft polymer that is formed on the surface of the polyimide base material (surface graft polymer) is formed by a method that is generally called a surface graft polymerization.

In the graft polymerization, energy is applied to the chain of the polymer compound so that active species is provided thereon to thereby further initiating polymerization of another polymerizable compound and thereby synthesize the graft polymer. When the polymer compound provided with the active species forms a solid surface, it is specifically called surface graft polymerization.

In the present invention, the compound having the polymerizable group and the group that interacts with either an electroless plating catalyst or a precursor thereof (hereinafter appropriately referred as an “interaction-property group”) is made to contact to the polyimide base material surface and subjected to the energy application so that the activation site is generated, and the activation site, the polymerizable group and the base material are reacted so as to cause the surface graft polymerization.

The above-mentioned contact may be conducted by dipping the base material in a liquid composition including the compound having the polymerizable group and the interaction-property group. However, in terms of easy handling and manufacturing efficiency, a layer whose main component is the composition including the compound having the polymerizable group and the interaction-property group is preferably formed on the base material surface through a coating process, which will be described later.

When the surface graft polymerization is conducted on both sides (surfaces) of a base material having a film shape or a plate shape, the both sides may be treated at once, or one side (surface) of the base material be surface graft-polymerized and then the other side (surface) of the base material be surface graft-polymerized.

Polymerizable Compound Having Interaction-Property Group

The compound having the polymerizable group and the interaction-property group used in the invention refers to a polymer in which an ethylene addition-polymerizable unsaturated group (polymerizable group) such as a vinyl group, allyl group or (meta) acrylic group is introduced as a polymerizable group into a monomer having the interaction-property group and described below or into a homopolymer and/or copolymer obtained by using at least one of the monomers having the interaction-property group. The polymer has the polymerizable functional group at least at a terminal or side chain thereof.

Examples of Monomers Having Interaction-Property Group

Examples of the monomers having the interaction-property group include a (meth)acrylic acid or an alkali metal salt or amine salt thereof, an itaconic acid, an alkali metal salt and amine salt thereof, a styrene sulfonic acid salt, 2-hydroxyethyl (meth)acrylate, (meth)acrylamide, N-monomethylol (meth)acrylamide, N-dimethylol (meth)acrylamide, arylamine or hydrohalic acid salt thereof, 3-vinylpropionic acid, an alkali metal salt and amine salt thereof, vinylsulfonic acid, an alkali metal salt and amine salt thereof, 2-sulfoethyl(meth)acrylate, polyoxyethylene glycol mono(meth)acrylate, 2-acrylamide-2-methylpropane sulfonic acid, acid phosphooxypolyoxyethyleneglycol mono(meth)acrylate, N-vinylpyrrolidone (having the following structure), vinyl benzoate or the like can be used. In general, a monomer including a functional group such as a carboxyl group, sulfonic acid group, phosphorous acid group, amino group, or salts thereof, hydroxyl group, amide group, phosphine group, imidazole group, pyridine group, or salts thereof, or ether group can be used.

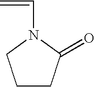

The compound having the polymerizable group and the interaction-property group can be synthesized as follows.

Examples of the synthesizing methods include i) a method in which a monomer having the interaction-property group and a monomer having the polymerizable group are copolymerized, ii) a method in which the monomer having the interaction-property group and a monomer having a double-bond precursor are copolymerized and then treated with a base or the like to introduce a double bond, and iii) a method in which the monomer having the interaction-property group and the monomer having the polymerizable group are reacted with each other to thereby introduce a double bond (the polymerizable group). Among these methods, ii) the method in which the monomer having the interaction-property group and the monomer having the double-bond precursor are copolymerized and then treated with a base or the like to introduce a double bond, and iii) the method in which the monomer having the interaction-property group and the monomer having the polymerizable group are reacted with each other to thereby introduce the polymerizable group are preferably employed in terms of a synthetic aptitude.

Specific examples of the monomer used for synthesizing the compound having the polymerizable group and the interaction-property group include (meta) acrylic acid, alkali metal salts and amine salts thereof, itaconic acid, alkali metal salts and amine salts thereof, 2-hydroxyethyl (meta) acrylate, (meta) acrylamide, N-monomethylol (meta) acrylamide, N-dimethylol (meta) acrylamide, allylamine or hydrohalic acid salt thereof, 3-vinylpropionic acid, alkali metal salts and amine salts thereof, vinylsulfonic acid, alkali metal salts and amine salts thereof, 2-sulfoethyl (meta)acrylate, polyoxyethyleneglycol mono(meta)acrylate, 2-acrylamide-2-nethylpropane sulfonic acid, acidphosphooxypolyoxyethyleneglycol mono(meta)acrylate, and N-vinylpyrrolidone (having the following structure) In general, monomers having a functional group such as a carboxyl group, sulfonic acid group, phosphorous acid group, amino group, or salts thereof, hydroxyl group, amide group, phosphine group, imidazole group, pyridine group, or salts thereof, or ether group can be used.

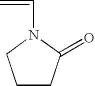

Examples of the monomer having the polymerizable group that can be copolymerized with the monomer having the interaction-property group include allyl (meta) acrylate and 2-allyloxyethyl methacrylate.

Examples of the monomer having the polymerizable group, which is used to introduce the unsaturated group utilizing the reaction with the functional group such as a carboxyl group or amino group or salt thereof, hydroxyl group, epoxy group or the like in the polymer having the interaction-property group, include (meta) acrylic acid, glycidyl (meta)acrylate, allylglycidyl ether, 2 isocyanatether (meta) acrylate and the like.

Next, ii) the method in which the monomer having the interaction-property group and the monomer having the double-bond precursor are copolymerized and then treated with a base or the like to introduce a double bond is explained in detail. The method ii) can use the method that is described in Japanese Patent Application Laid-Open (JP-A) No. 2003-335814. Examples of the monomer having the doublebond precursor include compounds described in JP-A No. 2003-335814 as compounds (i-1 to i-60). These monomers, the following compound (i-1) is preferably used. 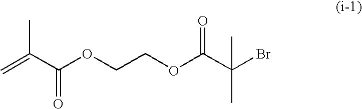
Base Used for Elimination Reaction

Preferable examples of the base used for introducing a double bond through the treatment with the base in the method ii) include hydrides, hydroxides, or carbonates of alkali metals, organic amine compounds, and metallic alkoxide compounds.

Preferable examples of the hydrides, hydroxides, or carbonates of alkali metals include sodium hydride, calcium hydride, potassium hydride, sodium hydroxide, potassium hydroxide, calcium hydroxide, potassium carbonate, sodium carbonate, potassium hydrocarbonate, sodium hydrocarbonate and the like.

Preferable examples of the organic amine compound include trimethylamine, triethylamine, diethymethyllamine, tributylamine, triisobutylamine, trihexylamine, trioctylamine, N,N-dimethylcyclohexylamine, N,N-dieyhylcyclohexylamine, N-methyldicyclohexylamine, N-ethyldicyclohexylamine, pyrrolidine, 1-methylpyrrolidine, 2,5-dimethylpyrrolidine, piperidine, 1-methylpiperlidine, 2,2,6,6-tetramehylpiperidine, piperazine, 1,4-dimethylpiperazine, quinuclidine, 1,4-diazabicyclo[2,2,2]-octane, hexamethylenetetramine, morpholine, 4-methylmorpholine, pyridine, picoline, 4-dimethylaminopyridine, lutidine, 1,8-diazabicyclo[5,4,0]-7-undecene (DBU), N,N′-dicyclohexylcarbodiimide (DCC), diisopropylethylamine, Schiff base, and the like.

Preferable examples of the metallic alkoxide compounds include sodium methoxide, sodium ethoxide, potassium t-butoxide and the like. These bases can be used singly or in a combination of two or more of them.

An amount of the base used may be equal to, more than, or less than an equivalent amount relative to functional group(s) which are precursor(s) for forming double bond(s) included in the compound. A temperature in the elimination reaction may be set to a room temperature, a cooling temperature or a heating temperature. A preferable temperature ranges from −20° C. to 100° C.

A macromonomer can also be used as the compound having the polymerizable group and the interaction-property group.

The macromonomer can be produced by means of, for example, various production methods proposed in the second chapter of “Synthesis of Macromonomers” in “Chemistry and Industry of Macromonomers” (edited by Yuya Yamashita.) published by IPC Press on Sep. 20, 1989. Examples of specifically effective macromonomers used in the invention include macromonomers induced from a monomer including a carboxyl group such as acrylic acid or methacrylic acid, sulfonic acid compound macromonomers induced from monomers such as 2-acrylamide-2-methylpropane sulfonic acid, vinylstyrene sulfonic acid or salts thereof, amide compound macromonomers induced from a (meta) acrylamide, N-vinylacetamide, N-vinylformamide or N-vinylcarboxylic acid amide monomer, macromonomers induced from monomers including a hydroxyl group such as hydroxyethylmethacrylate, hydroxyethylacrylate or glycerolmonomethacrylate, and macromonomers induced from monomers including an alkoxy group or ethyleneoxide group such as methoxyethylacrylate, methoxypolyethyleneglycolacrylate or polyethyleneglycolacrylate. Further, a monomer having a polyethyleneglycol chain or polypropyleneglycol chain can also be effectively used as a macromonomer used in the present mode.

An effective molecular weight of the macromonomers ranges from 250 to 100,000, and preferably from 400 to 30,000.

A solvent used for the described composition including the compound having the polymerizable group and the interaction-property group is not specifically limited as far as the compound having the polymerizable group and the interaction-property groupcan be dissolved in the solvent, and utilizable examples thereof include a water-soluble solvent and an organic solvent. A surfactant may be optionally added to the solvent.

Examples of the usable solvent include an alcohol solvent such as methanol, ethanol, propanol, ethyleneglycol, glycerin or propyleneglycolmonomethylether, acid such as acetic acid, a ketone solvent such as acetone or cyclohexanone, an amide solvent such as formamide or dimethylacetoamide, and the like.

Any surfactant can be added when necessary as far as it can be dissolved in the solvent. Examples of the usable surfactant include an anionic surfactant such as n-dodecylbenzene sodium sulfonate, a cationic surfactant such as n-dodecyltrimethyl ammonium chloride, a non-ionic surfactant such as polyoxyethylene nonylphenolether (as an example of a commercially available product, trade name: “EMULGEN 910, manufactured by Kao Corporation”), polyoxyethylene sorbitan monolaurate (as an example of a commercially available product, trade name: TWEEN 20), or polyoxyethylene laurylehter, and the like.

The compositions can be directly contacted in an arbitrary manner when the compositions are in liquid states. In the case of applying the composition on the surface of the base material through a coating process, a coating amount of the composition is preferably 0.1 to 10 g/m², and more preferably 0.5 to 5 g/m², based on a solid component, in view of obtaining a sufficient coating.

Energy Application

Examples of the energy application means for generating the activation site in the polymerization initiating site which is present on the surface of the polyimide base material include: heating; and radiation such as light exposure. Specific examples thereof include photoirradiation using a UV lamp or a visible light beam, heating by means of a hot plate, and the like.

Examples of a light source which can be used in the invention include a mercury vapor lamp, a metallic halide lamp, a xenon lamp, a chemical lamp, a carbon arc light, and the like. As further choices, g rays, i rays and deep-UV light can also be used.

A length of time required for the energy application is generally between ten seconds and five hours, however, it may vary depending on a desired generation amount of the graft polymer and light source.

As is described above, a surface grafted material is obtained by forming the graft polymer on the surface of the polyimide base material. The surface grafted material obtained in this process consists of the base material including: the polyimide having at least one structural unit selected from the group consisting of those represented by Formula (1) or Formula (2) and having the polymerization initiating site in a skeleton thereof; and the graft polymer that directly bonds to the surface of the base material. A conductive film is further formed on the surface grafted material by performing the imparting process for imparting the electroless plating catalyst or the like and the electroless plating process as described below so as to attach a conductive material to the graft polymer.

In the present invention, a polyimide base material, which has excellent heat resistance, is modified by surface grafting. Therefore, a conductive film which has excellent heat resistance can be formed by imparting a conductive material to the graft polymer by plating. Further, since the polyimide that constitutes the base material has a structural unit represented by Formula (1) or Formula (2), the polyimide base material can be prepared as that having low moisture absorption and high elasticity, and thereby a conductive material having excellent dimensional stability can be obtained.

Apart from the imparting of the conductive material, the surface grafted base material may be applied to materials having various functions by imparting other materials which interacts with the interaction-property group of the graft polymer on the surface of the base material (for example, functional microparticles, dyes, pigments or the like).

In the method for forming the conductive film of the present invention, the imparting process for imparting the electroless plating catalyst or the like and the electroless plating process are carried out after the surface grafting process, tehreby a conductive film (metallic film) having high heat resistance, excellent adherence to the surface of the base material and excellent dimensional stability is provided. A mechanism thereof has not been clarified, however, is expected as follows. The surface of the polyimide base material of the present invention is directly chemically bonded to the graft polymer that interacts with either an electroless plating catalyst or a precursor thereof. In the present invention, an electroless plating catalyst or a precursor thereof is imparted to the graft polymer that tightly bonded to the surface of the base material, and electroless plating is performed, so as to form the conductive film (metallic film) in or on a graft film. Therefore it is expected that, even if mechanical operations such as rubbing is added, the conductive film is not peeled off from the base material together with the graft polymer and is capable of improving adherence between the base material and the conductive film. Further, it is expected that since the present invention uses the polyimide base material, the conductive film having high heat resistance is realized. Hereinafter, the imparting process for imparting the electroless plating catalyst or the like and the electroless plating process are described in detail.

Imparting Electroless Plating Catalyst or the Like to Graft Polymer

The imparting process achieves imparting the electroless plating catalyst or preoursor thereof to the graft polymer formed in the surface grafting process.

Electroless Plating Catalyst

The electroless plating catalyst used in the present process is mainly a zero valent metal, and examples thereof include Pd, Ag, Cu, Ni, Al, Fe, Co and the like. In the invention, Pd and Ag are preferable in terms of easy handling and superiority of catalyzing ability. Examples of methods for fixing the zero valent metal in the interaction-property region includes applying a metallic colloid in which a charge is adjusted so as to interact with the interaction-property group in the interaction-property region to the interaction-property region. In general, the metallic colloid can be produced by reducing the metal ion in a solution in which a charged surfactant or a charged protective agent is present. The charge of the metallic colloid can be adjusted by the used surfactant or protective agent. When the metallic colloid in which the charge is thus adjusted is made to interact with the interaction-property group of the graft polymer, the metallic colloid (electroess plating catalyst) can be selectively adsorbed onto the graft polymer.

Precursor of Electroless Plating Catalyst

As the precursor of the electroless plating catalyst used in the present process, any substance can be employed without limitation as far as the substance can serve as the electroless plating catalyst through a chemical reaction, and the zero valent metal ion used in the electroless plating catalyst is mainly used. The metal ion, which is the precursor of the electroless plating catalyst, results in the zero valent metal serving as the electroless plating catalyst through a reduction reaction. The metal ion, which is the precursor of the electroless plating catalyst, is imparted to the base material, and then, may be changed into the zero valent metal through another reduction reaction before being dipped in an electroless plating catalyst plating bath to thereby constitute the electroless plating catalyst, or may be dipped in the electroless plating bath as the precursor of the electroless plating catalyst to be thereby changed into metal (electroless plating catalyst) by a reducing agent in the electroless plating bath.

The metal ion, which is the precursor of the electroless plating catalyst, is actually imparted to the graft polymer in the state of the metal salt. As the metal salt that is used any substance can be employed without limitation as far as the substance can be dissolved in an appropriate solvent and dissociated into the metal ion and base (anion). Specific examples of the metal salt include M(NO₃)ₙ, MClₙ, M_{2/n}(SO₄), M_{3/n}(PO₄) (in which M represents an n-valent metal atom) and the like. Examples of suitably used metal ion include the metal ions formed by dissociating the metal salts. Specific examples of the metal ion include an Ag ion, Cu ion, Al ion, Ni ion, Co ion, Fe ion, Pd ion and the like. The Ag ion and Pd ion are preferably used in terms of catalyzing ability.

As a method of imparting the metallic colloid as the electroless plating catalyst or the metal salt as the electroless plating precursor onto the graft polymer, the metallic colloid is dispersed in an appropriate dispersion medium or the metal salt is dissolved in an appropriate solvent so as to prepare a solution including the dissociated metal ion, and the solution is spread on the base material surface on which the graft polymer is present, or the base material having the graft polymer may be dipped in the solution. When the solution including the metal ion is brought into contact with the base material, the metal ion can be attached to the interaction-property group in the graft polymer utilizing an interion interaction or a dipole-ion interaction, or the interaction-property region can be impregnated with the metal ion. In order to thoroughly perform the attachment or impregnation, the concentration of the metal ion or concentration of the metal salt in the solution brought into contact, is preferably in the range of 0.01 to 50 mass %, and more preferably in the range of 0.1 to 30 mass %. A length of time required for the contact is preferably approximately one minute to 24 hours, and more preferably approximately five minutes to one hour.

Conducting Electroless Plating

In the present process, the electroless plating is performed to the base material, to which the electroless plating catalyst or the like has been imparted, and the conductive film (the metallic film) is thereby formed. More specifically, when the electroless plating is performed in the present process, the high-density conductive film (metallic film) in accordance with the graft polymer obtained in the above-described process is formed. The formed conductive film (metallic film) has a remarkable conductivity and adhesion property.

Electroless Plating

The electroless plating is an operation for depositing metal through a chemical reaction using a solution in which a metal ion, which is desirably deposited as plating, is dissolved.

In the electroless plating implemented in the present process, for example, the base material, which is obtained by the electroless plating catalyst-imparting process and to which the electroless plating catalyst is imparted, is washed with water so as to remove any excess electroless plating catalyst (metal) and dipped in the electroless plating bath. A generally known electroless plating bath can be used for the electroless plating bath in the present invention.

Further, when the base material, to which the precursor of the electroless plating catalyst is imparted, is dipped in the electroless plating bath in the state in which the precursor of the electroless plating catalyst is attached to or impregnated into the graft polymer, the base material is washed with water so as to remove any excess precursor (metal salt) and dipped in the electroless plating bath. In this case, the precursor is reduced and subsequently subjected to the electroless plating in the electroless plating bath. Similarly to the above-described case, a generally known electroless plating bath can also be used for the electroless plating bath in the present process.

A composition of the general electroless plating bath mainly includes a metal ion for plating, a reducing agent, and an additive for improving the stability of the metal ion (stabilizer). In addition to the foregoing components, the plating bath may further include a conventionally-known additive, such as a stabilizer for the plating bath.

Generally known kinds of the metal used for the electroless plating bath include copper, tin, lead, nickel, gold, palladium and rhodium. Among these, copper and gold are preferably used in terms of conductivity.

Further, there are reducing agents and additives, which are respectively optimal for the metals described above. For example, a copper electroless plating bath includes Cu(SO₄)₂ as copper salt, HCOH as reducing agent, and an additive such as EDTA as a stabilizer for the copper ion or a chelating agent such as Rochelle salt. A plating bath used for the electroless plating of CoNiP includes cobalt sulfate and nickel sulfate as the metal salt thereof, hypophosphite sodium as a reducing agent, and sodium malonate, sodium malate or sodium succinate as complexing agent. A palladium electroless plating bath includes (Pd(NH₃)₄)Cl₂ as metal ion, NH₃ or H₂NNH₂ as a reducing agent, and EDTA as stabilizer. These plating baths may include substances other than those mentioned.

A thickness of the conductive film (metallic film) thus formed can be controlled by the concentration of the metal salt or metal ion in the plating bath, time length of dipping in the plating bath, or temperature in the plating bath. The thickness is preferably at least 0.5 μm, and more preferably at least 3 μm, in terms of conductivity. A length of time required for dipping in the plating bath is preferably approximately one minute to 3 hours, and more preferably approximately one minute to one hour.

The conductive film (the metallic film) obtained as described above is formed by conducting plating onto a graft film having a high mobility, and the plating solution is thought to permeate into the inside of the graft film. Accordingly, it is expected that the interface between the metallic film and the substrate is in a hybrid state. It was confirmed through cross-sectional observations by means of an SEM that fine particles of the electroless plating catalyst and plating metal are densely dispersed in the surface graft film, and further that relatively large particles are deposited on the fine particles. Because the interface is in the hybrid state consisting of the graft polymer and the fine particles as is shown by the result, the adhesion property is favorable despite the unevenness being at most 100 nm or less at the interface between the base material (organic element) and inorganic substance (electroless plating catalyst or plating metal).

Electroplating

In the invention, electroplating (electroplating process) may be further included after performing electroless plating. In the electroplating process, the metallic film, which is formed in the electroless plating, can be used as an electrode so as to further perform the electroplating after the electroless plating. As a result, an additional metallic film having an arbitrary thickness can be easily formed based on the metallic film having the superior adhesion property to the base material. When the electroplating process is added, the metallic film can be adjusted to have an arbitrary thickness depending on the purpose thereof, which is favorable for applying the conductive material according to the embodiment to various applications.

Conventionally-known methods of performing electroplating can be applied to the implementation of the electroplating according to the invention. Examples of metals usable in the electroplating in the present invention include copper, chrome, lead, nickel, gold, silver, tin, zinc, and the like. Copper, gold and silver are preferable, and copper is particularly preferable in terms of conductivity.

A thickness of the metallic film obtained by the electroplating varies depending on the use thereof and can be controlled by adjusting a concentration of the metal included in the plating bath, dipping time or current density. A film thickness used for general electric wiring is preferably at least 0.3 μm, and more preferably at least 3 μm, in terms of conductivity.

2. Conductive Material

The conductive material of the invention is obtained by the above-described conductive film forming method of the invention, and characterized by having at least a a base material that includes a polyimide having at least one structural unit selected from the group consisting of those represented by Formula (1) or Formula (2) and having a polymerization initiating site in a skeleton thereof, a graft polymer that directly bonds to a surface of the base material, and a conductive substance that attaches to the graft polymer.

The conductive material of the invention is superior in dimensional stability, and a surface of the base material thereof is provided with a solid and uniform conductive film which is not peeled off by mechanical operations such as rubbing. Further, since the conductive material of the invention is superior in dimensional stability and heat resistance, it can be used for a flexible printed circuit (FPC) base plate, a Tape Automated Bonding (TAB) tape, a semi-conductive package, a rigid base plate circuit and the like. The invention has a broad application range, and can be modified for various settings in accordance with the purposes thereof.

### EXAMPLES

Hereinafter, the present invention is described in detail referring to examples. However, the invention is not limited to the described examples.

### Synthesis Example 1

Synthesis of Polyimide Precursor 1 (Polyamic Acid 1)

4,4′-diaminobenzophenone (28.7 mmol) was dissolved in N-methylpyrrolidone (30 ml) as a siamine compound in the presence of nitrogen and agitated at a room temperature for approximately 30 minutes.

p-phenylenebis(trimellitic acid monoester acid anhydride) (28.7 mmol) was added to the above solution at 0° C. and agitated for five hours. The reaction fluid was reprecipitated and a polyimide precursor 1 was obtained. The structure thereof was confirmed by means of ¹H-NMR and FT-1R.

Synthesis examples 2 to 8 and Comparative synthesis example 1

Polyimide precursors 2 to 8 and comparative polyamic acid 1 (polyamic acids 2 to 9), each of which has a composition shown in the following Table 1, were synthesized in a similar manner as in the synthesis example 1.

TABLE 1

| | Tetracarboxylic acid dianhydride | |
|---|---|---|
| | compound | Diamine compound |
| Synthesis Example 1 | p-phenylene-bis(trimellitic acid | 4,4′-diamino benzophenone: 28.7 |
| (Polyamic Acid 1) | anhydride): | mmol |
| | 28.7 mmol | |
| Synthesis Example 2 | p-phenylene-bis(trimellitic acid | 1,2-bis(4-aminophenyl)-2,2- |
| (Polyamic Acid 2) | anhydride): | dimethoxyethanone: 28.7 mmol |
| | 28.7 mmol | |
| Synthesis Example 3 | p-phenylene-bis(trimellitic acid | 4,4′-diaminothioxanthone: 28.7 |
| (Polyamic Acid 3) | anhydride): | mmol |
| | 28.7 mmol | |
| Synthesis Example 4 | 3,3′,4,4″-benzaphenone tetracarboxylic | 4,4′-bis(4-amino-N-o- |
| (Polyamic Acid 4) | acid dianhydride: 28.7 mmol | tolylbenzoamide): 28.7 mmol |
| Synthesis Example 5 | 3,3′,4,4″-benzaphenone tetracarboxylic | 4,4′-bis (4-aminobenzoamide)- |
| (Polyamic Acid 5) | acid dianhydride: 28.7 mmol | 3,3′-dihidroxybiphenyl: 28.7 mmol |
| Synthesis Example 6 | 3,3′,4,4″-benzaphenone tetracarboxylic | 4,4′-diaminodiphenylester: 28.7 |
| (Polyamic Acid 6) | acid dianhydride: 28.7 mmol | mmol |
| Synthesis Example 7 | 3,3′,4,4″-benzaphenone tetracarboxylic | bis(4-aminophenyl)terephthalate: |
| (Polyamic Acid 7) | acid dianhydride: 28.7 mmol | 28.7 mmol |
| Synthesis Example 8 | 3,3′,4,4″-benzaphenone tetracarboxylic | bis(4-aminophenyl)terephthalate: |
| (Polyamic Acid 8) | acid dianhydride: 28.7 mmol | 14.3 mmol |
| | | 4,4′-diamino benzophenone: 14.4 |
| | | mmol |
| Comparative Synthesis | 3,3′,4,4″-benzaphenone tetracarboxylic | 4,4′-diamino diphenyl ether: 28.7 |
| Example 1 | acid dianhydride: 28.7 mmol | mmol |
| (Polyamic Acid 9) | | |

Production of Polyimide Film

Each of the polyamic acids 1 to 8 and the comparative polyamic acid 1 synthesized in the above-mentioned method was dissolved in DMAc (manufactured by Wako Pure Chemical Industries, Ltd.) and formed into a solution of 30 wt %. The solution was spread on a glass substrate using a rod bar #36, dried at 100° C. for five minutes, heated at 250° C. for 30 minutes so as to solidify, and then was stripped off from the glass substrate. As a result, polyimide films 1 to 8 and comparative polyimide film 1 (respective thickness of 30 μm) were obtained.

### Example 1

Preparation of Surface Graft Polymer

The polyimide film 1 prepared according to the above-mentioned method was used as a substrate. A coating liquid having the following composition was coated on the substrate using a rod bar #18. A thickness of the film formed on the base material was 0.8 μm. Exposure was then carried out with respect to the obtained film using a 1.5 kW high-pressure mercury-vapor lamp for ten minutes. Thus obtained film was washed with water. Surface graft polymer was introduced on the entire surface of the base material thereby.

Composition of coating liquid

| | | |
|---|---|---|
| Polymer including a polymerizable group | 0.25 | g |
| (synthesized in the following method) | | |
| Cyclohexanone | 8.0 | g |

Method of Synthesizing Above-Described Polymer Having Polymerizable Group

58.6 g of 2-hydroxyethylmetahacrylate was put in a three-neck flask having a 500 ml capacity and 250 ml of acetone was added thereto and then agitated. 39.2 g of pyridine and 0.1 g of p-methoxyphenol were further added thereto, and then cooled down in a cooling bath using ice water. After a temperature of the mixed fluid reached 5° C. or below, 114.9 g of 2-bromoisobutanoic acid bromide was dropped therein by means of a dropping funnel over a period of three hours. After the dropping was completed, the mixed fluid was removed from the cooling bath and further agitated for three hours. The reaction mixed fluid was charged into 750 ml of water and agitated for one hour. The mixed fluid combined with water was extracted three times using 500 ml of acetic ether by means of separating funnel. An organic layer was washed sequentially with 500 ml of hydrochloric acid (1 mol/l), 500 ml of an aqueous solution of saturated sodium hydrocarbonate, and 500 ml of saturated salt water. The organic layer was provided with 100 g of magnesium sulfate, and dehydrated and dried, and then, filtrated. 120.3 g of a monomer A was obtained by vacuum-distilling the solvent.

Next, 40 g of N,N-dimethylacetamide was charged into a three-neck flask having a 1000 ml capacity and heated to 70° C. in the presence of nitrogen. 40 g of the N,N-dimethylacetamide solution including 12.58 g of the monomer A, 27.52 g of methacrylic acid and 0.921 g of a thermal polymerization initiating agent (trade name: V601, manufactured by Wako Pure Chemical Industries, Ltd.) was dropped therein over a period of 2.5 hours. After the dropping was completed, the solution was heated to 90° C. and further agitated for two hours. The reaction solution was cooled down to room temperature and charged into 3.5 L of water so that a polymer compound was deposited. The deposited polymer compound was filtrated, washed with water and dried, and as a result, 30.5 g of the polymer compound was obtained. A weight average molecular weight of the obtained polymer compound was measured by means of a gel permeation chromatography method (GPC) in which a standard material was polystyrene, and the obtained result was 124.000.

26.0 g of the obtained polymer compound and 0.1 g of p-methoxyphenol were charged into a three-neck flask having a 200 ml capacity and dissolved in 60 g of N,N-dimethylacetamide and 60 g of acetone, and then cooled down in the cooling bath using ice water. After a temperature of the mixed fluid reached 5° C. or below, 60.4 g of 1,8-diazabicyclo[5.4.0]-7-undecene (DBU) was dropped therein over a period of one hour by means of a dropping funnel. After the dropping was completed, the fluid was removed from the cooling bath and further agitated for eight hours. The reaction fluid was charged into 2 L of water in which 17 ml of concentrated hydrochloric acid was dissolved, and a polymer having a polymerizable group was thereby deposited. The deposited polymer having the polymerizable group was filtrated, washed with water and dried. Then, 15.6 g of the polymer was obtained.

Electroless Plating

The thus obtained substrate was dipped in an aqueous solution including 0.1 wt % of paladium nitrate (manufactured by Wako Pure Chemical Industries, Ltd.) for one hour, washed with ion-exchanged water, and subjected to electroless plating in an electroless plating bath containing the following composition for 10 minutes, and thus a conductive film 1 was formed to provide a conductive material 1 of Example 1.

Composition of electroless plating bath

| | | |
|---|---|---|
| OPC KAPPA-H T1 (trade name, an electroless plating solution | 6 | ml |
| manufactured by Okuno Chemical Industries Co., Ltd.) | | |
| OPC KAPPA -H T2 (trade name, an electroless plating solution | 1.2 | ml |
| manufactured by Okuno Chemical Industries Co., Ltd. | | |
| OPC KAPPA -H T3 (trade name, an electroless plating solution | 10 | ml |
| manufactured by Okuno Chemical Industries Co., Ltd.) | | |
| Water | 83 | ml |

### Example 2

The metallic film 1 formed in Example 1 was further subjected to electroplating in an electroplating bath containing the following composition for 30 minutes, and thus a conductive film 2 was formed to provide a conductive material 2 of Example 2.

Composition of electroplating bath

| | | |
|---|---|---|
| Copper sulfate | 38 | mg |
| Sulfuric acid | 95 | g |
| Chloric acid | 1 | ml |
| Brightening agent (trade name KAPPA-GREEM PCM, | 3 | ml |
| manufactured by Meltex Inc.) | | |
| Water | 500 | ml |

### Example 3

A conductive material 3 of Example 3 was formed in the same manner as conductive material 1 of Example 1, except that the polyimide film 2 was used instead of the polyimide film 1 and an electroplating was further performed in the same manner as in Example 2 so as to form a conductive film 3.

### Example 4

A conductive material 4 of Example 4 was formed in the same manner as conductive material 3 of Example 3, except that the polyimide film 3 was used instead of the polyimide film 2 so as to form a conductive film 4.

### Example 5

The polyimide film 4 was used as a substrate. The substrate was dipped in an aqueous solution including acrylic acid (10 wt %) and sodium periodic acid (NaIO₄, 0.01 wt %) and subjected to photoirradiation using a 1.5 kW high-pressure mercury-vapor lamp for ten minutes in an argon atmosphere. A film obtained as a result of the photoirradiation was washed with ion-exchanged water. Thus surface graft polymer of acrylic acid was introduced onto the entire surface of the substrate so as to form a graft film A.

Electroless Plating and Electroplating

The thus obtained graft film A was dipped in an aqueous solution of saturated sodium hydrocarbonate, washed with ion-exchanged water, subjected to electroless plating in an electroless plating bath containing the composition used in Example 1 for 10 minutes, and subjected to electroplating in an electroplating bath containing the composition used in Example 2 for 30 minutes, thus a conductive film 5 was formed to provide a conductive material 5 of Example 5.

### Example 6

A conductive material 6 of Example 6 was formed in the same manner as conductive material 5 of Example 5, except that the polyimide film 8 was used instead of the polyimide film 4 so as to form a conductive film 6.

### Example 7

A graft film B was obtained in the same manner as the graft film A in Example 5, except that the polyimide film 5 as used as the substrate instead of the polyimide fim 4.

The thus obtained graft film B was dipped in an aqueous solution of metallic fine powder dispersant prepared in accordance with the following process. Then the surface of the graft film B was sufficiently washed with flowing water so as to remove excess metallic powders. A metallic fine powder attached-film was thus prepared.

Process of Preparing Metallic Fine Powder Dispersant

3 g of bis(1,1-trimethylammoniumdecanoyl aminoethyl) disulfide was added to 50 ml of an ethanol solution of silver perchlorate (5 mM), and thus obtained mixture was vigorously agitated while slowly being added with 30 ml of an aqueous solution of sodium boron hydride (0.4 M) so as to obtain the dispersant containing silver fine particles which are coated with quaternary ammonium. A measurement of sizes of the silver fine particles was conducted, and it turned out that an average diameter of the silver fine particles was 5 nm.

The thus obtained graft film B was subjected to electroless plating in an electroless plating bath containing the composition used in Example 1 for 10 minutes, and subjected to electroplating in an electroplating bath containing the composition used in Example 2 for 30 minutes, thus a conductive film 7 was formed to provide a conductive material 7 of Example 7.

### Example 8

A conductive material 8 of Example 8 was formed in the same manner as conductive material 7 of Example 7, except that the polyimide film 6 was used instead of the polyimide film 5 so as to form a conductive film 8.

The polyimide film 7 was used as a substrate. The substrate was dipped in an aqueous solution sodium styrene sulfonate (10 wt %) subjected to photoirradiation using a 1.5 kW high-pressure mercury-vapor lamp for ten minutes in an argon atmosphere. A film obtained as a result of the photoirradiation was sufficiently washed with ion-exchanged water. Thus surface graft polymer of sodium styrene sulfonate was introduced onto the entire surface of the substrate so as to form a graft film C.

Electroless plating and Electroplating

The thus obtained graft film C was dipped in an aqueous solution of silver nitrate (10 wt %), washed with distilled water, subjected to electroless plating in an electroless plating bath containing the composition used in Example 1 for 10 minutes, and subjected to electroplating in an electroplating bath containing the composition used in Example 2 for 30 minutes, thus a conductive film 9 was formed to provide a conductive material 9 of Example 9.

### Example 10

The polyimide film 1 was used as a substrate. A coating liquid having the same composition used in Example 1 was coated on one side (surface) of the substrate using a rod bar #18. A thickness of the film formed on the substrate was 0.8 gum. Exposure was then carried out with respect to the obtained film using a 1.5 kW high-pressure mercury-vapor lamp for ten minutes. Thus obtained film was washed with an aqueous solution of saturated sodium hydrocarbonate. Surface graft polymer was thus introduced on the one side (surface) of the substrate thereby. Further, the coating liquid was coated on the other side (rear surface) of the substrate using a rod bar #18. Exposure was then carried out with respect to the obtained film using a 1.5 kW high-pressure mercury-vapor lamp for ten minutes. Thus obtained film was washed with an aqueous solution of saturated sodium hydrocarbonate. Surface graft polymer was thus introduced on both sides of the substrate thereby.

The thus obtained substrate was subjected to electroless plating in the same manner as in Example 1, and subjected to electroplating in the same manner as in Example 2, thus a conductive film 10, in which both sides (surfaces) of the polyimide base material was plated, was formed to provide a conductive material 10 of Example 10.

### Comparative Example 1

A conductive material 11 of Comparative example 1 was formed in the same manner as conductive material 1 of Example 1, except that the comparative polyimide film 1 was used instead of the polyimide film 1 and electroplating was further performed in the same manner as in Example 2 so as to form a conductive film 11.

Evaluation

1. Evaluation of Conductivity

Conductivities of the conductive materials 1 to 11 were evaluated by measuring surface resistances (Ω/□) thereof by four point probe method.

2. Evaluation of Adhesion Property

Adhesion property of the conductive materials 1 to 11 were evaluated by conducting the conventionally-known 90 degrees-peeling test method of copper-clad laminates for printed wiring boards with respect to the conductive materials 1 to 11, which were partially cut with a width of 5 mm so as to peel copper films off therefrom

3. Evaluation of Heat Resistance

The conductive materials 1 to 11 were heated at 250° C. for one minute, and the surfaces of the conductive materials 1 to 11 were observed by naked eyes so as to evaluate the heat resistance tehreof in accordance with the following criteria.

Evaluation Criteria
A: No stripping of the conductive material was observed.
B: Stripping of the conductive material was observed.
   4. Evaluation of Dimensional Stability

Markings for measuring the dimensional change ratio were made on the copper layer (copper film) of each of the conductive materials 1 to 11 at two locations (a, b) by making holes using an NC drill. At this time the spacing of a to b was measured, giving the first length value L1. Then after etching the entire surface of the copper film, the spacing of a to b was measured again, giving the second length value L2. Then, according to the calculation equation shown below, the ratio (%) of the dimensional change before and after etching was calculated.

$$\text{Dimensional change ratio (\%)} = \frac{L1 - L2}{L2} \times 100$$

The results are shown in Table 2.

TABLE 2

| | | | Adhe- | | |
|---|---|---|---|---|---|
| | | Surface | sion | | Dimen- |
| | | resis- | pro- | Heat | sional |
| | Conductive | tance | perty | Resis- | stabil- |
| | film (No.) | (Ω/□) | (kN/m) | tance | ity (%) |
| Example 1 | Conductive film 1 | 1.0 | 0.6 | A | +0.02 |
| Example 2 | Conductive film 2 | >0.01 | 0.5 | A | +0.04 |
| Example 3 | Conductive film 3 | >0.01 | 0.5 | A | +0.05 |
| Example 4 | Conductive film 4 | >0.01 | 0.5 | A | +0.03 |
| Example 5 | Conductive film 5 | >0.01 | 0.5 | A | +0.04 |
| Example 6 | Conductive film 6 | >0.01 | 0.5 | A | +0.03 |
| Example 7 | Conductive film 7 | >0.01 | 0.5 | A | +0.05 |
| Example 8 | Conductive film 8 | >0.01 | 0.4 | A | +0.04 |
| Example 9 | Conductive film 9 | >0.01 | 0.4 | A | +0.05 |
| Example 10 | Conductive film 10 | >0.01 | 0.5 | A | +0.05 |
| Comparative | Conductive film 11 | >0.01 | 0.4 | A | −0.18 |
| Example 1 | | | | | |

As is shown in Table 2, in the conductive films 1 to 10 of the Examples a good result was achieved for all of conductivity, adhesion of the conductive film to the base material, heat resistance and dimensional stability. In contrast to that it is clear that, in the base material of the Comparative Example 1, which does not contain the specific polyimide of the invention, whereas similar results were achievable for conductivity, adhesion, and heat resistance, the dimensional stability was inferior.

1. A method for forming a conductive film comprising:
applying energy to a surface of a base material including a polyimide having at least one structural unit selected from the group consisting of those represented by the following Formula (1) or Formula (2) and having a polymerization initiating site in a skeleton thereof to generate an activation site on the surface of the base material;
forming a graft polymer that directly bonds to the surface of the base material and that interacts with either an electroless plating catalyst or a precursor thereof by using the activation site as a starting point;
applying either an electroless plating catalyst or a precursor thereof to the graft polymer; and
electroless plating: 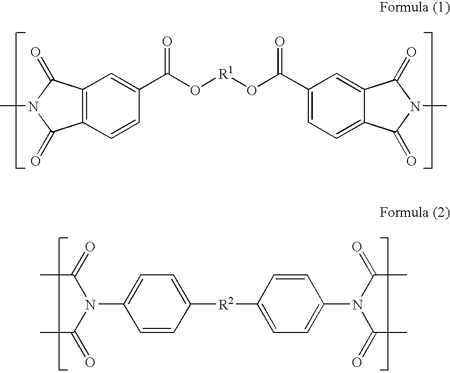
in Formulae (1) and (2), R¹ represents a bivalent organic group, and R² represents a partial structure represented by one of Formulae (3) to (6). 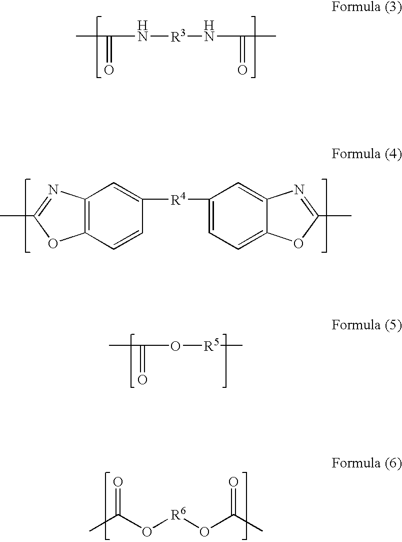
in Formulas (3) to (6), each of R³, R⁴, R⁵ and R⁵ independently represents a bivalent organic group.

2. The method for forming a conductive film of claim 1, further comprising conducting electroplating.

3. The method for forming a conductive film of claim 1, wherein the base material including the polyimide has a film shape or a plate shape, and conductive films are formed on both surfaces of the base material.

4. The method for forming a conductive film of claim 2, wherein the base material including the polyimide has a film shape or a plate shape, and conductive films are formed on both surfaces of the base material.

5. The method for forming a conductive film of claim 1, wherein in Formula (1), R¹ represents a bivalent organic group selected from the group consisting of a straight-, a branched- or a cyclic-aliphatic group which may have a substituent, and a straight-, a branched- or a cyclic-aromatic group which may have a substituent.

6. The method for forming a conductive film of claim 1, wherein in Formulae (3) to (6), R³, R⁴, R⁵ and R⁵ independently represents a bivalent organic group selected from the group consisting of a straight-, a branched- or a cyclic-aliphatic group which may have a substituent, and a straight-, a branched- or a cyclic-aromatic group which may have a substituent.

7. The method for forming a conductive film of claim 1, wherein the polymerization initiating site is included in a main chain of a polymer skeleton of the the polyimide.

8. The method for forming a conductive film of claim 1, wherein the base material is formed by changing a structure of a polyimide precursor into a polyimide structure through a heating process.

9. A conductive material comprising:
a base material including a polyimide having at least one structural unit selected from the group consisting of those represented by the following Formula (1) or Formula (2) and having a polymerization initiating site in a skeleton thereof to generate an activation site on the surface of the base material; and
a conductive film comprising a graft polymer that directly bonds to the surface of the base material and a conductive material that is attached to the graft polymer: 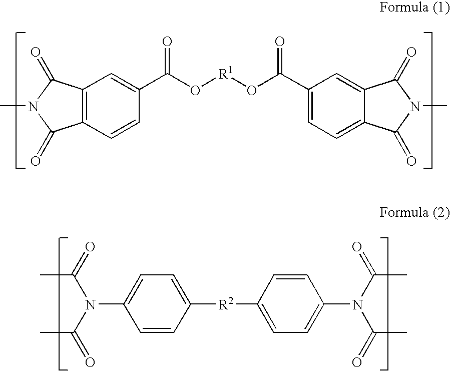
in Formulae (1) and (2), R¹ represents a bivalent organic group, and R² represents a partial structure represented by one of Formulae (3) to (6). 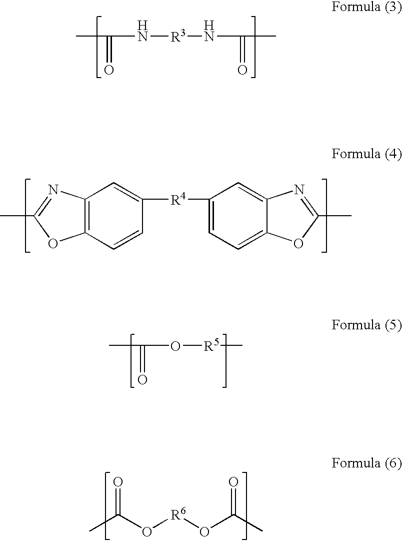
in Formulas (3) to (6), each of R³, R⁴, R⁵ and R⁵ independently represents a bivalent organic group.

10. The method for forming a conductive film of claim 9, wherein the base material including the polyimide has a film shape or a plate shape, and conductive films are formed on both surfaces of the base material.

11. The method for forming a conductive film of claim 9, wherein in Formula (1), R¹ represents a bivalent organic group selected from the group consisting of a straight-, a branched- or a cyclic-aliphatic group which may have a substituent, and a straight-, a branched- or a cyclic-aromatic group which may have a substituent.

12. The method for forming a conductive film of claim 9, wherein in Formulae (3) to (6), R³, R⁴, R⁵ and R⁵ independently represents a bivalent organic group selected from the group consisting of a straight-, a branched- or a cyclic-aliphatic group which may have a substituent, and a straight-, a branched- or a cyclic-aromatic group which may have a substituent.

13. The method for forming a conductive film of claim 9, wherein the polymerization initiating site is included in a main chain of a polymer skeleton of the the polyimide.

14. The method for forming a conductive film of claim 9, wherein the base material is formed by changing a structure of a polyimide precursor into a polyimide structure through a heating process.
